(19) United States
(12) Patent Application Publication
(10) Pub. No.: US 2016/0256948 A1
(43) Pub. Date: Sep. 8, 2016

(54) FLUX-LESS DIRECT SOLDERING BY ULTRASONIC SURFACE ACTIVATION

(71) Applicant: NORTHEASTERN UNIVERSITY, Boston, MA (US)

(72) Inventors: Teiichi ANDO, Belmont, MA (US); Somayeh Gheybi HASHEMABAD, Boston, MA (US)

(21) Appl. No.: 15/029,208

(22) PCT Filed: Oct. 21, 2014
(86) PCT No.: PCT/US14/61537

§ 371 Date: Apr. 13, 2016

Related U.S. Application Data
(60) Provisional application No. 61/894,122, filed on Oct. 22, 2013.

(51) Int. Cl. B23K 1/06; B23K 35/02; B23K 20/10; B23K 20/233; B23K 1/19; B23K 20/02

(52) U.S. Cl. CPC B23K 1/06; B23K 1/19; B23K 20/023; B23K 20/10; B23K 20/2336; B23K 35/025; B23K 2203/10

(57) ABSTRACT

A solder joint and a method of making the same is described. The solder joint includes, a first metal part; a second metal part; and solder material disposed between the first and second metal parts; such that the solder material forms a joint with the first and second metal parts; and the solder material has a plurality of abrasive particles disposed therein. The method includes contacting the solder material with the abrasive particles; placing the solder material and the abrasive particles between the first and second metal parts to form a layered structure; applying a compressive force on the layered structure; applying ultrasonic vibration for a predetermined time to the layered structure to remove the passive oxide layer of the metal part; and applying heat to the layered structure to cause the solder material to melt and flow between the metal parts and form a bond with the metal parts.

### RELATED APPLICATION

This application claims the benefit of the earlier filing date of U.S. Patent Application No. 61/894,122, filed on Oct. 22, 2013, the contents of which are incorporated by reference herein in its entirety.

### TECHNICAL FIELD

The field of this application generally relates to solder joints of metals and alloys that form a passive oxide film and a method of forming the same.

### BACKGROUND

Non-Ferrous metals and alloys, such as aluminum and titanium and their alloys, are excellent structural materials due to their light weight and high strength. Additionally, they offer superior corrosion resistance as compared with ferrous alloys. The superior corrosion resistance of these alloys typically is attributed to the passive oxide film that is formed instantaneously when the metal or alloy is exposed to the atmosphere.

However, this very attribute results in a drawback, rendering these metals and alloys unsuitable for forming joints using processes such as soldering. Since the passive oxide is instantly reformed after cleaning and the solder does not bond well with these oxides, currently the industry has to resort to techniques such as inert gas welding, fluxed soldering and brazing to successfully form joints with solder the solder material.

It is advantageous to form a joint between the metals and alloys that form passive oxides and solder material without the need for a flux, costly surface treatments or complicated equipment as required in inert gas welding for mitigating the formation of the passive oxide film. Such a technique may be used for providing economical means for joining an aluminum or aluminum alloy to a metallic or ceramic part. Examples of applications that can benefit from such a joint are, but not limited to, soldering of aluminum heat-exchanger fins to EV invertors and joining aluminum parts to steel parts of intake manifolds.

### SUMMARY

In an aspect, a solder joint includes, a first metal part; a second metal part; and solder material disposed between the first and second metal parts; such that the solder material forms a joint with the first and second metal parts; and the solder material has a plurality of abrasive particles disposed therein.

In some embodiments, the first metal part is made from a metal capable of forming a passive oxide layer on the surface.

In any of the above embodiments, the second metal part is made from a metal capable of forming a passive oxide layer on the surface.

In any of the above embodiments, the metal is an aluminum alloy.

In any of the above embodiments, the metal is a titanium alloy.

In any of the above embodiments, the solder material is selected from a group containing tin-lead-based solder alloys and lead-free tin-based solder alloys. In any of the above embodiments, wherein the solder material is brass.

In any of the above embodiments, the solder material is group consisting of silver and silver-based alloys.

In any of the above embodiments, the abrasive particle is selected from a group consisting of alumina, sand, calcite, emery, novaculite, pumic, rouge, garnet, sandstone, Tripoli, powdered feldspar, staurolite, carborundum, SiC, SiN, ceramic aluminum oxide, ceramic iron oxide, zirconia alumina, boron carbide, cubic boron nitride, diamond, and mixtures thereof.

In any of the above embodiments, the abrasive has an average particle size greater than 0.1 μm, or greater than 0.3 μm, or greater than 0.5 μm, or greater than 0.8 μm, or greater than 1 μm, or greater than 3.0 μm, or greater than 5.0 μm, or greater than 10.0 μm, or greater than 15.0 μm.

In any of the above embodiments, the abrasive particles are distributed preferentially at the interface of the solder material and the metal parts.

In any of the above embodiments, the abrasive particles are distributed throughout the solder material.

In any of the above embodiments, the solder joint has an ultimate tensile strength greater than 30 MPa.

In an aspect, a method of making a solder joint including, contacting a solder material with abrasive particles; locating the solder material and the abrasive particles between first and second metal parts to form a layered structure; applying a compressive force on the layered structure; applying ultrasonic vibration for a predetermined time to the layered structure to remove the passive oxide layer of the metal part; and applying heat to the layered structure to cause the solder material to melt and flow between the metal parts and form a bond with the metal parts.

In some of embodiments, the method of contacting of the solder material with the abrasive particles includes depositing the particles on the surface of the solder material by sedimentation of the abrasive particles from a slurry of the abrasive particles.

In some of embodiments, the method of contacting of the solder material with the abrasive particles includes coating a sheet of the solder material with the abrasive slurry.

In some of embodiments, the method of contacting of the solder material with the abrasive particles includes mixing the solder material particles with the abrasive particles.

In any of the above embodiments, the ultrasonic vibration has a frequency of greater than 15 kHz.

In any of the above embodiments, the compressive force is applied normal to the plane separating the metal parts.

In any of the above embodiments, the compressive force is greater than 15 MPa.

In any of the above embodiments, the applied heat raises the temperature of the solder material above 100° C. In some of the above the above embodiments, wherein, the applied heat raises the temperature of the solder material above 150° C.

### BRIEF DESCRIPTION OF THE DRAWINGS

The following figures are provided for the purpose of illustration only and are not intended to be limiting.

FIG. 1 illustrates a schematic of a flux-less metal joint in accordance with this disclosure.

FIG. 2 illustrates a schematic showing sedimentation based method for contacting the solder material with the abrasive;

FIG. 3A illustrates a schematic for the ultrasonic activation of the passive oxide forming metal part in the layered structure including metal parts, solder material and abrasive particles;

FIG. 3B illustrates is a schematic of a STAPLA Condor® ultrasonic welding machine used for producing the solder joint;

FIG. 3C illustrates a schematic for the heating of the ultrasonically activated layered structure to form the bond between the solder material and the metal part ;

FIG. 4 is a schematic of an embodiment of the heater plate;

FIG. 5 is an embodiment of a control box for the heater plate;

FIG. 6 is an embodiment of the wiring diagram for the heater box;

FIG. 7 illustrates an Al-solder joint produced by ultrasonic activation and reflowing with a preconsolidated solder sheet with abrasive disposed on the surface of the consolidated solder sheet;

FIG. 8 illustrates an Al-solder joint produced by ultrasonic activation and reflowing with solder powder mixed with abrasive powder such as corundum;

FIG. 9A illustrates a schematic for the ultrasonic activation of the metal or alloy surfaces in the layered structure including metal parts, solder material and abrasive particles;

FIG. 9B illustrates a schematic for the ultrasonically activated layered structure to form the bond between the solder material and the metal parts;

FIG. 10 illustrates an aluminum-solder-aluminum joint produced by ultrasonic activation and reflowing produced with a preconsolidated solder sheet; and

FIG. 11 illustrates the joint strength of an aluminum-solder-aluminum joint produced by ultrasonic activation and reflowing produced with a preconsolidated solder sheet;

### DETAILED DESCRIPTION

A flux-less solder joint that facilitates a joint between two metal parts, wherein abrasive particles are disposed in the solder material, is described.

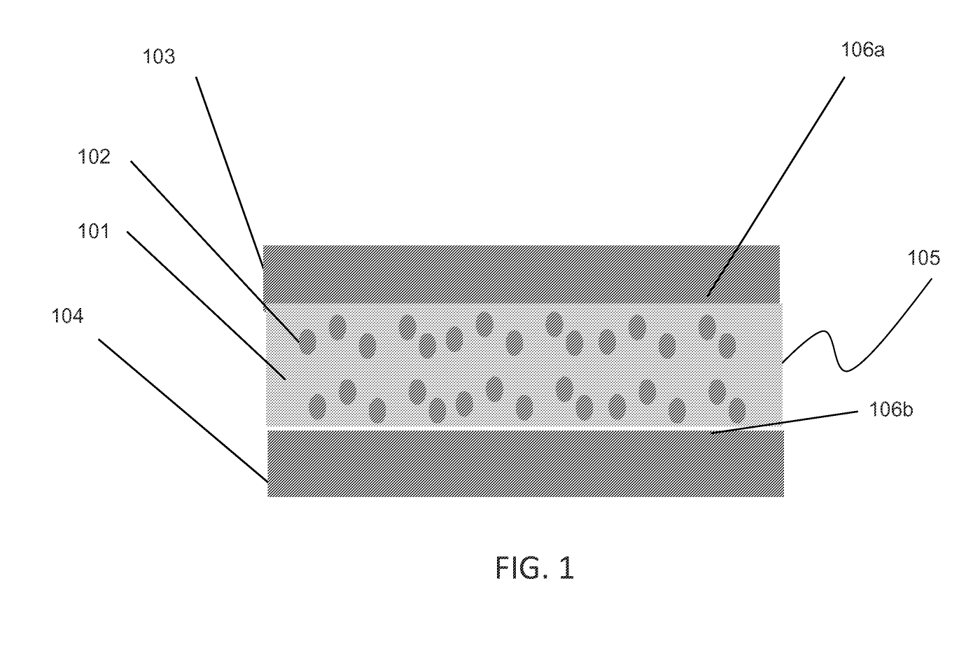

FIG. 1 shows a schematic of an embodiment of a metal joint in accordance with this disclosure. The abrasive particles 101 are disposed in the solder material 102, which is disposed between the metal parts 103 and 104, to form the solder sheet 105. The solder material bonds to the metal pieces 103 and 104 at interface 106a and 106b, respectively.

In one or more embodiments, the metal parts are selected from metals and alloys that form passive oxide layers on the surface due to oxidation in presence of atmospheric oxygen. In one or more embodiments, the metal parts are aluminum or aluminum alloys. In some embodiments, the metal parts are titanium or titanium alloys.

There is no fundamental restriction on the type and chemical composition of the solder material that can be used according to one or more embodiments. The use of solder materials with a low melting temperature is contemplated since it makes the metal parts less prone to oxidation, as discussed below, and minimizes the overheating of parts being joint which minimizes the residual stress in the resultant solder joint. it is proposed. In some embodiments the solder material is a tin-lead or lead-free tin-based solder alloy. In some other embodiments, the solder material is brass. In some embodiments, the solder material is silver or a silver-based alloy. Other materials such as metals, including those used for brazing, may also be compatible to the ultrasonic abrasive surface activation method.

There is no fundamental restriction on the type and chemical composition of the abrasive material that can be used according to one or more embodiments. In some embodiments the abrasive material disposed in the solder material of the joint is selected from alumina, sand, calcite, emery, novaculite, pumic, rouge, garnet, sandstone, tripoli, powdered feldspar, staurolite, carborundum, SiC, SiN, ceramic aluminum oxide, ceramic iron oxide, zirconia alumina, boron carbide, cubic boron nitride, diamond, and mixtures thereof. In some embodiments, the average particle size, characterized by the d₅₀ particle size distribution, is greater than 0.1 μm. In some embodiments, the average particle size of the abrasive is greater than 0.3 μm, or greater than 0.5 μm, or greater than 0.8 μm, or greater than 1 μm, or greater than 3.0 μm, or greater than 5.0 μm, or greater than 10 .0 μm, or greater than 15.0 μm. Particle size ranges bounded by any of the values identified hereinabove are also contemplated, e.g., 0.1 μm-15.0 μm, or 0.1 μm-10 .0 μm or 0.5 μm-5.0 μm, etc.

In some embodiments, the abrasive particles are disposed randomly throughout the solder material of the joint. In some embodiments, the abrasive particles are disposed in the vicinity of the interface between the metal part and the solder material.

In some embodiments, the metal or alloy-solder material interface is free of an passive oxide layer, thereby facilitating a direct contact of the metal or alloy part with the solder material. It is this direct contact, in the absence of the oxide layer, that is attributed to the superior bond strength and results in the high ultimate tensile strengths for the joint.

In another aspect, a method of making a solder joint is described. In some embodiments the method includes contacting the solder material with the abrasive particles; placing the solder material and the abrasive particles between the first and second metal parts to form a layered structure; applying a compressive force on the layered structure; applying ultrasonic vibration for a predetermined time to the layered structure to remove the passive oxide layer of the metal part; and applying heat to the layered structure to cause the solder material to melt and flow between the metal parts and form a bond with the metal parts.

In some other embodiments, contacting the abrasive particles with the solder material includes applying the abrasive particles on the solder material by techniques such as suspension sedimentation, aerosol techniques, and physical and chemical vapor deposition. In some other embodiments, the abrasive particles may be placed on the metal part surface, after which the solder layer is placed in between the parts.

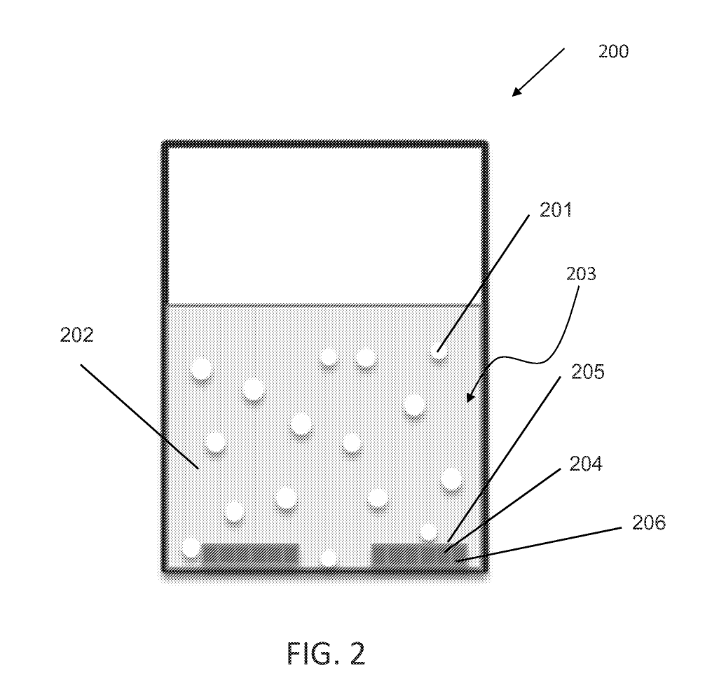

In some embodiments, the contacting of the abrasive particles with the solder material includes preparation of a slurry of the abrasive. In some embodiments the abrasive slurry is made by dispersing the abrasive particles of the desired particle size in a solvent such as ethanol. This is schematically shown in FIG. 2 where in the abrasive particles 201 are dispersed in ethanol which acts as a solvent 202 to form the abrasive slurry 203. In some embodiments, the abrasive particles 201 are alumina or corundum particles of average particle size of 1.0 μm. In the above slurry 203, the solder sheet 204, which are prepared by compacting powder of the solder material, are immersed and the abrasive particles sediment on to the top surface 205 of the solder sheet. In some embodiments, when both the sides of the solder sheet needs to have abrasive disposed on it, the process is repeated with the surface 206 facing the top and exposed to the abrasive slurry 202. In some embodiments, the mass of the abrasive particles 201 deposited on the consolidated solder sheet 204 was about 1-2 g/m² by adjusting the concentration of abrasive particles 201 present in the slurry.

In some other embodiments, the surface of the solder sheet is coated with the abrasive slurry to dispose the abrasive on the surface of the solder sheet. The coating may be performed by any of the conventional application methods, such a, but not limited to, dip coating, roll coating, draw down, spraying and brushing on.

In some other embodiments, the abrasive particles are mixed with the solder material and this mixtures is disposed between the metal parts to be joint. In some embodiments, the mixture of the solder particles and the abrasive may be compacted to form a sheet prior to being disposed between the metal parts or may be disposed as a mixture of particles of abrasive and solder material. Without being bound by theory, the concentration of the abrasive particles in the solder material should be high enough to have sufficient number of abrasive particles disposed on the surface of the compacted solder sheet such that they are available to remove the passive oxide layer as described later in this document.

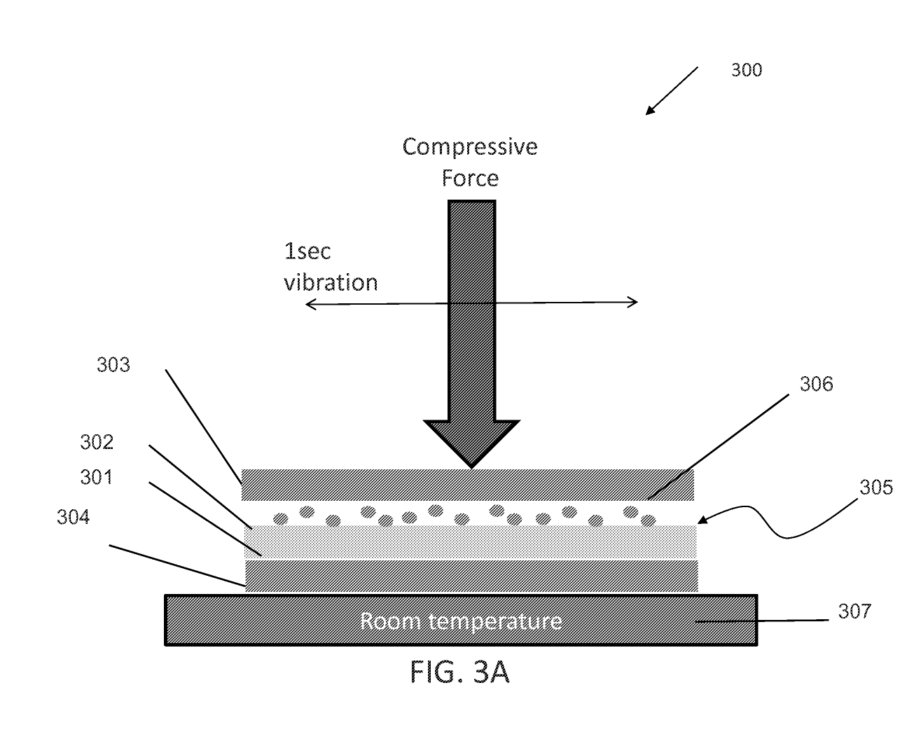

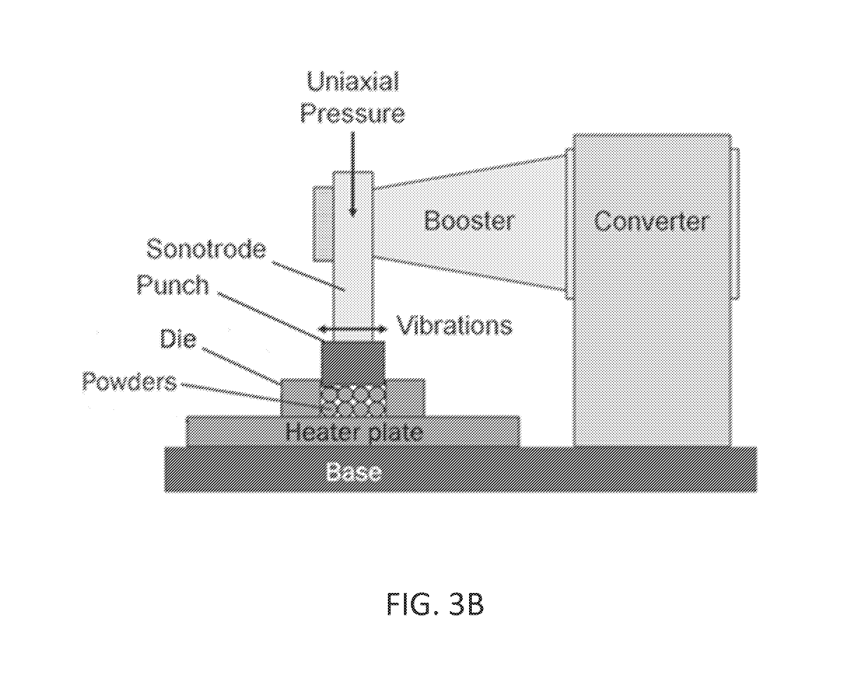

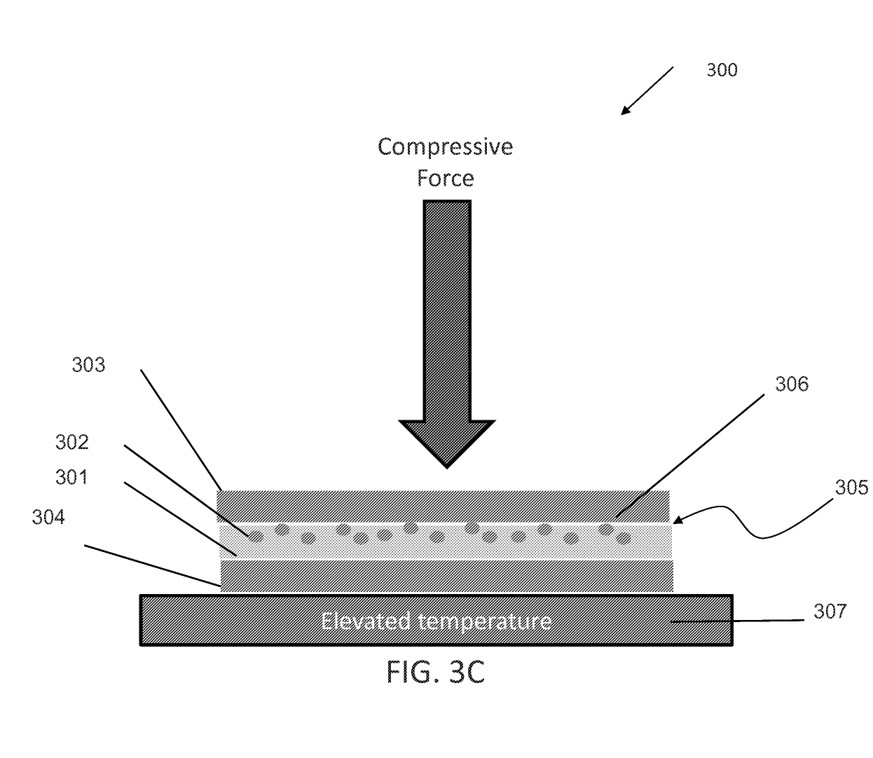

In some embodiments, the solder material with the abrasive particles disposed on one surface is placed between the metal parts that are to be joined with the abrasive particles disposed on the side of the solder sheet that is to form contact with the metal part which forms a passive oxide layer. This is schematically shown in FIG. 3A. where the solder material 301 containing the abrasive particles 302 on the top surface is disposed between the metal parts 303 and 304. In this configuration, metal part 303 forms a passive oxide. In some embodiments, 303 is an aluminum metal or an aluminum alloy. In some other embodiments, the metal 304 is a nickel foil. The layered structure 305, including the two metal parts 303 and 304, along with the solder material 303 with the abrasive particles 302, is placed in an ultrasonic welding apparatus for surface initiation.

A compressive force is applied on the layered structure 305 along with an ultrasonic vibration for a predetermined amount of time. The compressive force can be applied by any of the conventional methods known to one skilled in the art. In some embodiments, the part is compressed in a hydraulic press. In some other embodiments the part is compressed by application of weight. In some embodiments the compressive force applied is greater than 15 MPa; or greater than 20 MPa; or greater than 40 MPa. Pressure ranges bounded by any of the values identified hereinabove are also contemplated, e.g., 15 MPa-40 MPa, or 15 MPa-20 MPa or 20 MPa-40 MPa, etc.

In some embodiments the vibration source is an ultrasonic welding machine a STAPLA Condor® ultrasonic welding unit is used for ultrasonic consolidation. A schematic of the ultrasonic welding machine is shown in FIG. 3B. In some embodiments, the frequency of vibration is 20 kHz. The amplitude of vibration is adjustable by changing the level of power. In some embodiments, the maximum power that is applied is 3 kW. which produces an amplitude of vibration of 9 μm. The UPC setup is connected to a controller, which transmits high frequency signals to the converter that generates ultrasonic vibration.

In some embodiments, the frequency of vibration used is 15 kHz, or 20 kHz, or 30 kHz, or 35 kHz, or 40 kHz, or 45 kHz, or 50 kHz, or 60 kHz. Frequency ranges bounded by any of the values identified hereinabove are also contemplated, e.g., or 15 kHz-60 kHz, or 20 kHz-60 kHz, or 15 kHz-40 kHz, or 20 kHz-40 kHz, or 20 kHz-30 kHz. In some embodiments, the amplitude of vibration used is less than 100 μm, or less than 80 μm, or less than 60 μm, or less than 40 μm, or less than 20 μm, or less than 3 μm. Amplitude ranges bounded by any of the values identified hereinabove are also contemplated, e.g., or 3 μm-100 μm, or 3 μm-80 μm, or 3 μm-60 μm, or 20 μm-80 μm, or 40 μm-100 μm. The duration the vibration is applied is 1 second. Other frequencies, amplitudes and time durations, not specified here, may be selected as long as the ultrasonic activation is sufficient to abrade the passive oxide layer that is present on the metal or alloy part.

Without being bound by theory, the process of surface initiation causes the passive oxide layer on the metal parts to be abraded and removed. Since the passive oxide is instantly reformed after cleaning and the solder does not bond well with these oxides the bond strength is significantly impaired. However, due to the compressive force being exerted on the layered structure 305, the interface is devoid of oxygen and fresh passive oxide cannot be formed back in accordance with the current disclosure. Thus, providing a clean, oxide free surface on interface 306 of metal part 303 to which the solder material can adequately bond in the subsequent heating step.

Once the vibration is stopped, the layered structure 305 is heated by heating the nickel foil through a hot plate 307. This is schematically depicted in FIG. 3C. The temperature of the hot plate is adjusted to cause the temperature of the solder material 301 to rise up above its liquidus value. However, the temperature is maintained so as to not go past the liquidus value of the metal parts 303 and 304. This causes the solder material 301 to melt and reflow and form a metallurgical bond with the metal 303 and 304. In some embodiments the layered structure 305 is heated to a temperature above 100° C. In some other embodiments the layered structure 305 is heated to a temperature above 150° C., or above 200° C., or above 220° C., or above 230° C., or above 250° C. Temperature ranges bounded by any of the values identified hereinabove are also contemplated, e.g., 150° C.-250° C., or 200° C.-250° C. or 250° C.-300° C., etc.

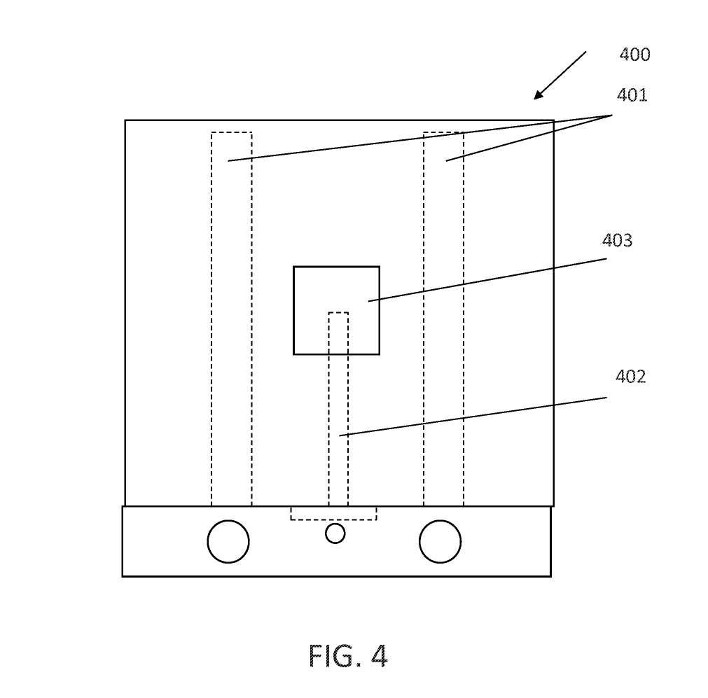

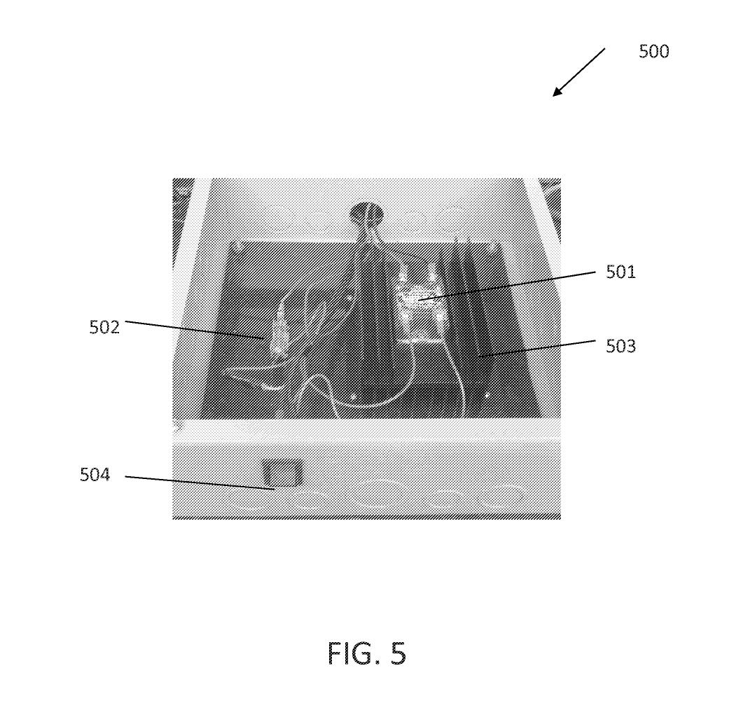

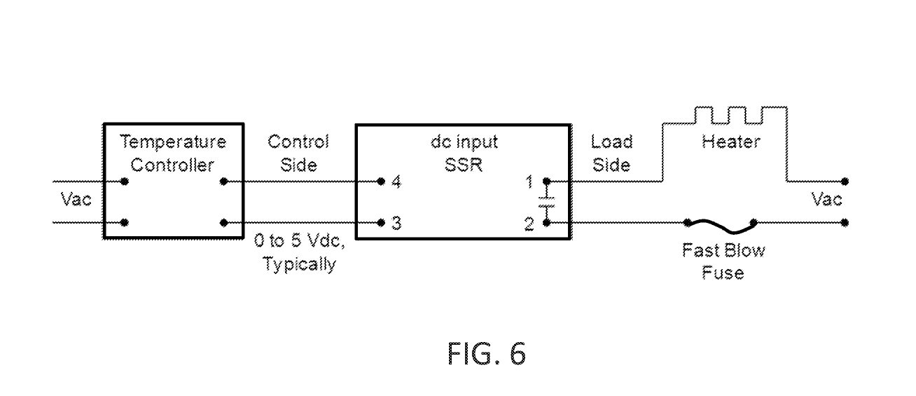

In some embodiments, the UPC setup also includes a hot plate which facilitate operation at elevated temperatures. In some embodiments, two cartridge heaters 401 such as, TUTCO, 9.5 mm diameter, 51 mm length, 400 W; and a K-type thermocouple probes 402, such as, OMEGA Model SP-GP-K-6, are inserted in the stainless steel heater plate below the die holder 403. This is shown schematically in FIG. 4. In some embodiments, the heater plate temperature is controlled through a K-type thermocouple connected to a PC via a control box and a National Instruments (NI) PCI-6035E multifunction data acquisition (DAQ) card through a NI BNC-2110 connector block as shown in FIG. 5. The control box 500 consists of a solid state relay (SSR) 501, a fuse block with a 250 V, 5 A fuse 502, and an Omega FHS-7 finned heat sink 503 and on/off button 504. A suitable wiring diagram that may be used is provided in FIG. 6. In some embodiments, a computer program, coded on LabView 8.6, obtains the temperature data from the thermocouple and sends signals to the heaters to heat the heater plate to the set temperature. In some embodiments, the program is set to record the temperature data with a sampling rate of 1000 data points per second. In some embodiments, additional K-type thermocouples are used to monitor the specimen temperature during processing.

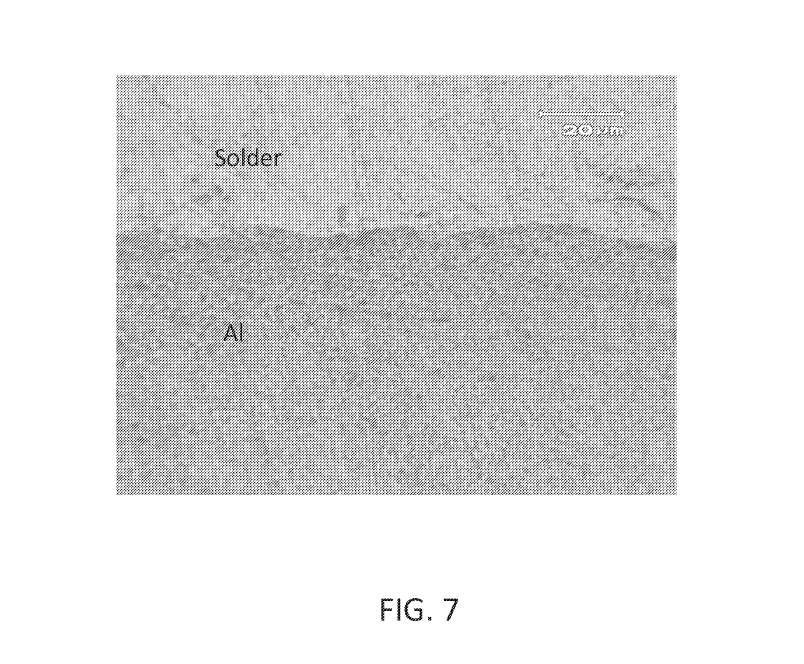

FIG. 7 illustrates an Al-solder joint produced by ultrasonic activation and reflowing as described above with a preconsolidated solder sheet with abrasive disposed on the surface of the consolidated solder sheet.

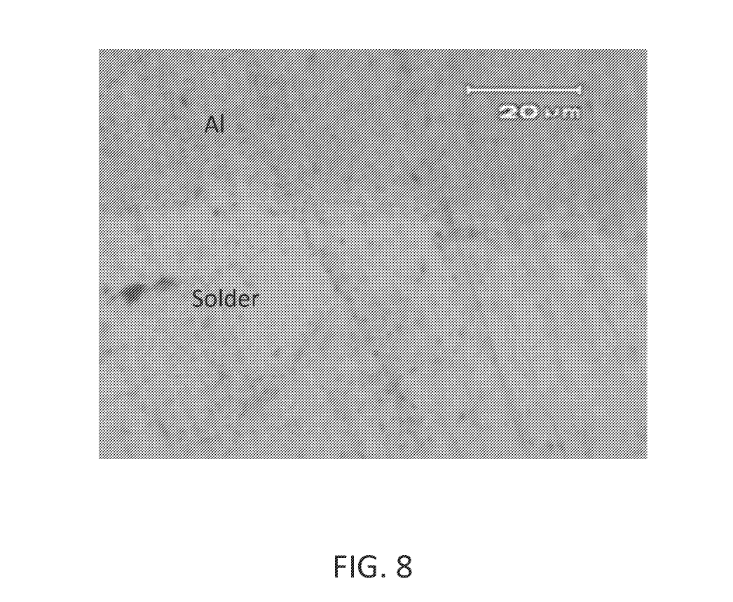

FIG. 8 illustrates an Al-solder joint produced by ultrasonic activation and reflowing as described above with solder powder mixed with abrasive powder such as corundum.

The process used for making the Al-solder joint shown in FIG. 7 was repeated with no abrasive particles mixed with the solder powder. No bonding between the solder and the aluminum was obtained in this case demonstrating that the removal of the passive oxide layer is essential for the bonding between the metal and solder to take place.

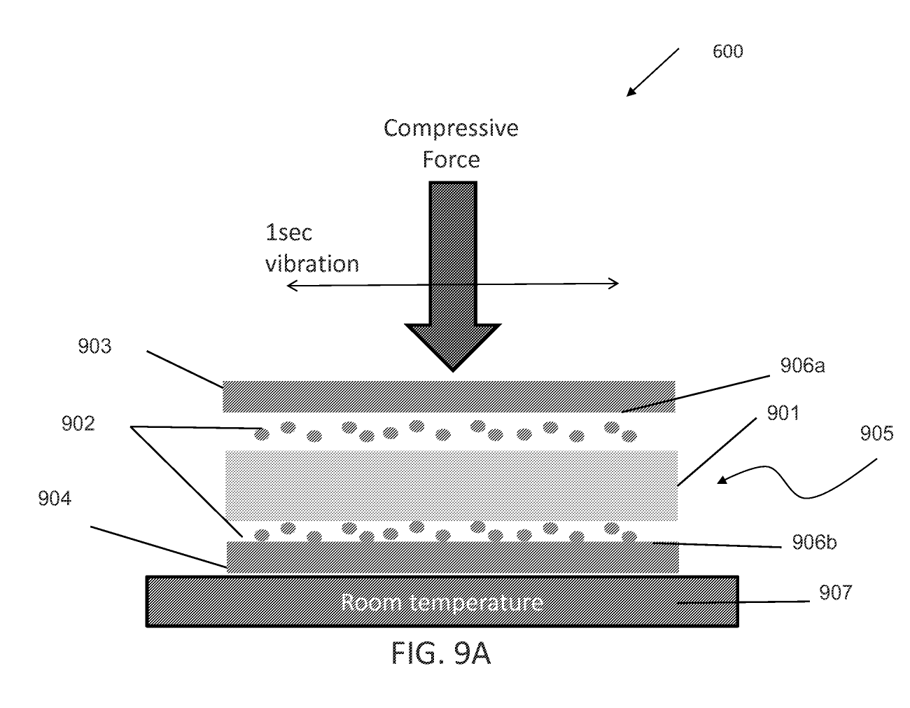

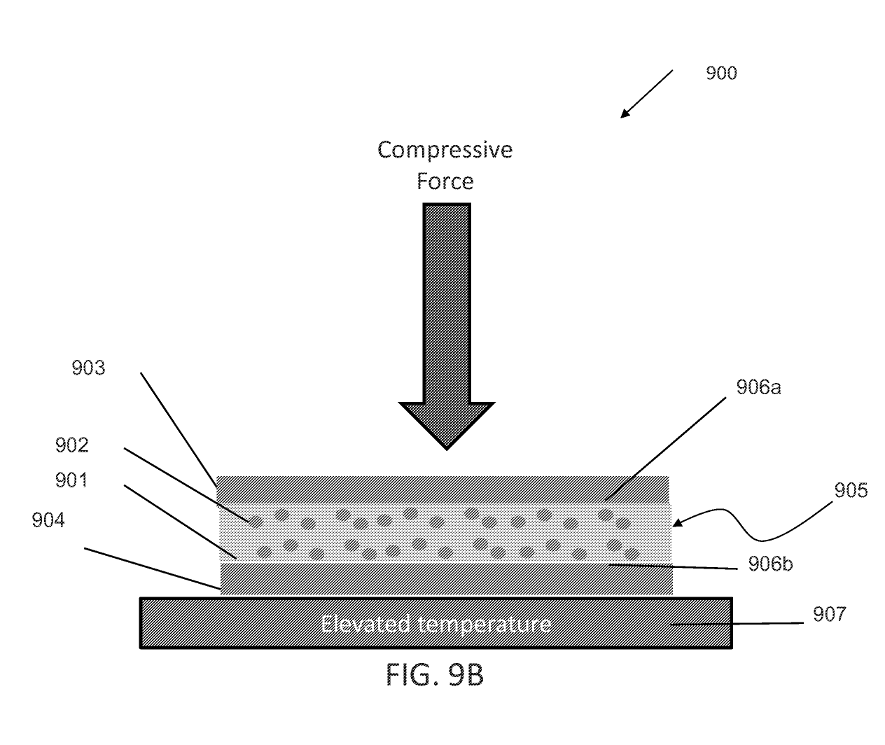

FIG. 9A illustrates a schematic for the ultrasonic activation of the metal or alloy surfaces in the layered structure including metal parts, solder material and abrasive particles. In some embodiments, the solder material 901 with abrasive particles 902 on both sides of the solder sheet is placed between the metal parts 903 and 904 that at to be joint to form the layered structure 905. In this case both the metal parts 903 and 904 are metals or alloys that form passive oxides that inhibit the formation of a proper metallurgical joint between the metal and the solder material. This passive oxide is to be removed from surfaces 906a and 906b in the ultrasonic activation step. In some embodiments, 903 and 904 are parts made of aluminum metal or an aluminum alloys. In other embodiments, the solder material is consolidated solder sheet with abrasive particles distributed randomly throughout the cross section of the consolidated solder sheet. In some other embodiments, the solder material is a powder which is blended with the abrasive particle and this mixture is disposed between the metal parts 903 and 904.

A compressive force is applied on the layered structure 905 along with an ultrasonic vibration for a predetermined amount of time. The compressive force can be applied by any of the conventional methods known to one skilled in the art. In some embodiments, the part is compressed in a hydraulic press. In some other embodiments the part is compressed by application of weight. In some embodiments the compressive force applied is greater than 15 MPa; or greater than 20 MPa; or greater than 40 MPa.

In some embodiments the vibration source is an ultrasonic welding machine. In some embodiments the frequency and amplitude of the vibration applied is 20 kHz and 9 μm, respectively. In some embodiments, the frequency of vibration used is 15 kHz, or 20 kHz, or 30 kHz, or 35 kHz, or 40 kHz, or 45 kHz, or 50 kHz, or 60 kHz. Frequency ranges bounded by any of the values identified hereinabove are also contemplated, e.g., or 15 kHz-60 kHz, or 20 kHz-60 kHz, or 15 kHz-40 kHz, or 20 kHz-40 kHz, or 20 kHz-30 kHz. In some embodiments, the amplitude of vibration used is less than 100 μm, or less than 80 μm, or less than 60 μm, or less than 40 μm, or less than 20 μm, or less than 3 μm. Amplitude ranges bounded by any of the values identified hereinabove are also contemplated, e.g., or 3 μm-100 μm, or 3 μm-80 μm, or 3 μm-60 μm, or 20 μm-80 μm, or 40 μm-100 μm. The duration the vibration is applied is 1 second. Other frequencies, amplitudes and time durations, not specified here, may be selected as long as the ultrasonic activation is sufficient to abrade the passive oxide layer that is present on the metal or alloy part.

Without being bound by theory, the process of surface initiation causes the passive oxide layer on the metal parts to be abraded and removed. Since the passive oxide is instantly reformed after cleaning and the solder does not bond well with these oxides the bond strength is significantly impaired. However, due to the compressive force being exerted on the layered structure 905, the interface is devoid of oxygen and fresh passive oxide cannot be formed back in accordance with the current disclosure. Thus, providing a clean, oxide free surface on interface 906a and 906b of metal part 903 and 904 to which the solder material can adequately bond in the subsequent heating step.

Once the vibration is stopped, the layered structure 905 is heated through a hot plate 607. This is schematically depicted in FIG. 9B. The temperature of the hot plate is adjusted to cause the temperature of the solder material 901 to rise up above its liquidus value. However, the temperature is maintained so as to not go past the liquidus value of the metal parts 603 and 904. This causes the solder material 901 to melt and reflow and form a metallurgical bond with the metal 903 and 604 at interface 906a and 906b. In some embodiments the layered structure 905 is heated to a temperature above 100° C. In some other embodiments the layered structure 905 is heated to a temperature above 150° C., or above 200° C., or above 220° C., or above 230° C., or above 250° C.

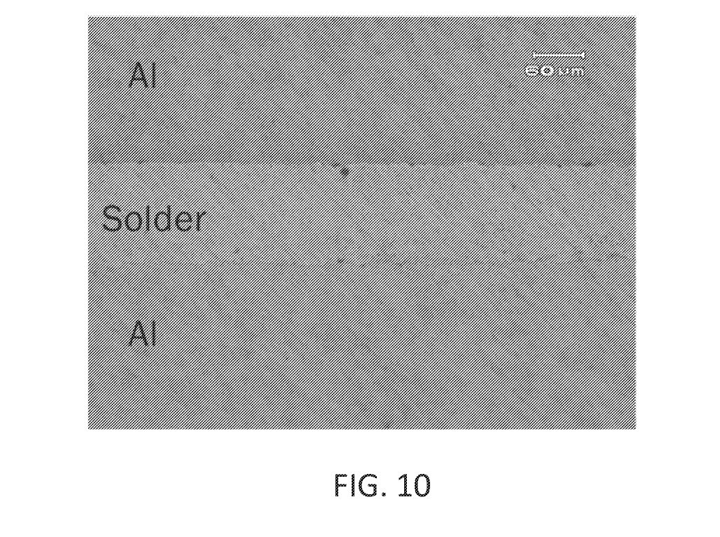

FIG. 10 illustrates an aluminum-solder-aluminum joint produced by ultrasonic activation and reflowing produced with a preconsolidated solder sheet.

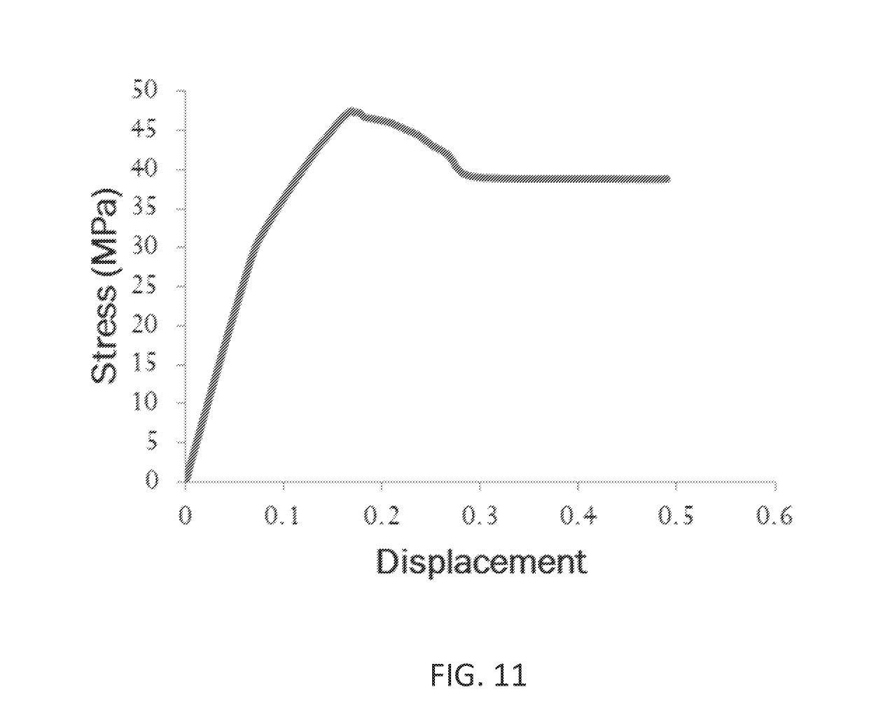

FIG. 11 illustrates the joint strength of an aluminum-solder-aluminum joint produced by ultrasonic activation and reflowing produced with a preconsolidated solder sheet. The stress strain curve shows that the aluminum-solder-aluminum joint has an ultimate tensile strength greater than 45 MPa. In other embodiments, ultimate tensile strength greater than 35 MPa, or ultimate tensile strength greater than 25 MPa or ultimate tensile strength greater than 15 MPa may be obtained.

1. A solder joint comprising:
a first metal part;
a second metal part; and
solder material disposed between the first and second metal parts;
wherein the solder material forms a joint with the first and second metal parts; and
wherein the solder material has a plurality of abrasive particles disposed therein.

2. A solder joint according to claim 1, wherein, the first metal part is made from a metal capable of forming a passive oxide layer on the surface.

3. A solder joint according to claim 1, wherein, the second metal part is made from a metal capable of forming a passive oxide layer on the surface.

4. A solder joint according to claim 1, wherein, the metal is an aluminum alloy.

5. A solder joint according to claim 1, wherein, the metal is a titanium alloy.

6. A solder joint according to claim 1, wherein, the solder material is selected from a group containing tin-lead-based solder alloys and lead-free tin-based solder alloys.

7. A solder joint according to claim 1, wherein, the solder material is brass.

8. A solder joint according to claim 1, wherein, the solder material is group consisting of silver and silver-based alloys.

9. A solder joint according to claim 1, wherein, the abrasive particle is selected from a group consisting of alumina, sand, calcite, emery, novaculite, pumic, rouge, garnet, sandstone, Tripoli, powdered feldspar, staurolite, carborundum, SiC, SiN, ceramic aluminum oxide, ceramic iron oxide, zirconia alumina, boron carbide, cubic boron nitride, diamond, and mixtures thereof.

10. A solder joint according to claim 9, wherein, the abrasive particle comprises alumina.

11. A solder joint according to claim 9, wherein, the abrasive particle is corundum.

12. A solder joint according to claim 9, wherein, the abrasive has an average particle size greater than 0.1 μm, or greater than 0.3 μm, or greater than 0.5 μm, or greater than 0.8 μm, or greater than 1 μm, or greater than 3.0 μm, or greater than 5.0 μm, or greater than 10.0 μm, or greater than 15.0 μm.

13. A solder joint according to claim 1, wherein, the abrasive particles are distributed preferentially at the interface of the solder material and the metal parts.

14. A solder joint according to claim 1, wherein, the abrasive particles are distributed throughout the solder material.

15. A solder joint according to claim 1, wherein, the solder joint has an ultimate tensile strength greater than 30 MPa.

16. A method of making a solder joint comprising:
contacting a solder material with abrasive particles;
locating the solder material and the abrasive particles between first and second metal parts to form a layered structure;
applying a compressive force on the layered structure;
applying ultrasonic vibration for a predetermined time to the layered structure to remove the passive oxide layer of the metal part; and
applying heat to the layered structure to cause the solder material to melt and flow between the metal parts and form a bond with the metal parts.

17. The method of claim 16, wherein, the contacting of the solder material with the abrasive particles comprises of depositing the particles on the surface of the solder material by sedimentation of the abrasive particles from a slurry of the abrasive particles.

18. The method of claim 16, wherein, the contacting of the solder material with the abrasive particles comprises of coating a sheet of the solder material with the abrasive slurry.

19. The method of claim 16, wherein, the contacting of the solder material with the abrasive particles comprises mixing the solder material particles with the abrasive particles.

20. The method of claim 16, wherein, the ultrasonic vibration has a frequency of greater than 15 kHz.

21. The method of claim 16, wherein, the compressive force is applied normal to the plane separating the metal parts.

22. The method of claim 16, wherein, the compressive force is greater than 15 MPa.

23. The method of claim 16, wherein, the applied heat raises the temperature of the solder material above 100° C.

24. The method of claim 16, wherein, the applied heat raises the temperature of the solder material above 150° C.
